(19) United States
(12) Patent Application Publication
(10) Pub. No.: US 2010/0245689 A1
(43) Pub. Date: Sep. 30, 2010

(54) PROJECTOR

(75) Inventor: Tomoharu MASUDA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/730,760

(22) Filed: Mar. 24, 2010

(30) Foreign Application Priority Data
Mar. 26, 2009 (JP) 2009-075939

(51) Int. Cl. G02F 1/1335

(52) U.S. Cl. 349/8

(57) ABSTRACT

A projector includes: a light modulation device that changes the polarization state of incident light; and a polarization maintaining reflector provided along the outer edge of an effective pixel area in the light modulation device, the polarization maintaining reflector having a flat surface that reflects the incident light with its polarization state maintained.

### BACKGROUND

1. Technical Field

The present invention relate to a projector that uses a light modulator to modulate illumination light and projects the modulated image light.

2. Related Art

An exemplary known projector of related art uses what is called a reflective liquid crystal panel that reflects light in a light modulation process, in particular, includes a black-painted frame for holding a quarter-wave plate or a phase difference compensation element disposed between the liquid crystal panel and a polarizing beam splitter (see JP-A-2007-233407). A projector using what is called a transmissive liquid crystal panel that transmits light in a light modulation process also employs a technique of painting a member around the liquid crystal panel black or attaching a black tape to the member for light blocking purposes (see JP-A-2006-106364).

Blocking unwanted light, for example, by painting a particular member black, however, may not completely absorb the unwanted light but causes part of the unwanted light component to scatter, resulting in leakage of light in some cases. In particular, irregularities on the surface painted black or otherwise made black can disturb the polarized state of the unwanted light that has not been absorbed, resulting in leakage of the light component whose polarized state is the same as that of the modulated light to be outputted from the liquid crystal panel. In this case, for example, a projector using a reflective liquid crystal panel projects the leakage light component along with the modulated light, possibly resulting in decrease in contrast of the projected image. Further, the unabsorbed unwanted light contributes to stray light.

### SUMMARY

An advantage of some aspects of the invention is to provide a projector capable of suppressing decrease in contrast of a projected image resulting from unwanted light produced around a liquid crystal panel or any other light modulation device.

A projector according to a first aspect of the invention includes a light modulation device that changes the polarization state of incident light, and a polarization maintaining reflector provided along the outer edge of an effective pixel area in the light modulation device, the polarization maintaining reflector having a flat surface that reflects the incident light with its polarization state maintained.

In the projector described above, since the polarization maintaining reflector provided along the outer edge of the effective pixel area has a flat surface that reflects the incident light with its polarization state maintained, the polarization state of unwanted light incident on a portion outside the effective pixel area will not be disturbed, and hence a light component whose polarization state coincides with that of modulated light will not be produced from the unwanted light. The projector described above can therefore reduce the amount of leakage light and stray light produced from the unwanted light and hence suppress the decrease in contrast of a projected image when illumination light emitted from a light source is modulated by the light modulation device and projected through a projection system.

A projector according to a second aspect of the invention includes a light modulation device that changes the polarization state of incident light, and a polarized light absorber provided along the outer edge of an effective pixel area in the light modulation device, the polarized light absorber absorbing a specific polarized light component of the light components of the incident light.

In the projector described above, since the polarized light absorber provided along the outer edge of the effective pixel area absorbs a specific polarized light component of the light components of the incident light, a light component whose polarization state coincides with that of modulated light will not be produced from unwanted light incident on a portion outside the effective pixel area. The projector described above can therefore reduce the amount of leakage light and stray light produced from the unwanted light and hence suppress the decrease in contrast of a projected image when illumination light emitted from a light source is modulated by the light modulation device and projected through a projection system.

It is preferred that the light modulation device is a reflective liquid crystal panel, and that the projector further includes a polarization separation element that transmits one of a light component polarized in a first direction and a light component polarized in a second direction contained in the light incident on the light modulation device and reflects the other polarized light component. In this case, the transmission or the reflection at the polarization separation element allows non-modulated light and an unwanted light component having returned from the portion outside the effective pixel area to be separated from modulated light outputted from the reflective liquid crystal panel.

It is preferred that the projector further includes an optical compensator that compensates the polarization state of the light incident on the light modulation device and a compensator frame that surrounds and supports the optical compensator along the outer edge of the effective pixel area of the light modulation device, and that the polarization maintaining reflector or the polarized light absorber is formed on the compensator frame. In this case, the polarization state of the unwanted light can be appropriately adjusted at the compensator frame.

It is preferred that the polarization maintaining reflector in the projector according to the first aspect of the invention is formed by carrying out a process in which the surface of the compensator frame undergoes a mirror processing operation. In this case, the surface of the compensator frame that is formed by using the mirror processing operation can reflect the unwanted light with its polarization state maintained.

It is preferred that the polarization maintaining reflector in the projector according to the first aspect of the invention is formed by using MIRO for the compensator frame. In this case, the surface of the compensator frame that is formed by using MIRO can reflect the unwanted light with its polarization state maintained.

It is preferred that the polarization maintaining reflector in the projector according to the first aspect of the invention is formed by carrying out a process in which the surface of the compensator frame undergoes a mirror finishing operation. In this case, the surface of the compensator frame that is formed by using a mirror finishing operation can reflect the unwanted light with its polarization state maintained.

It is preferred that the polarized light absorber in the projector according to the second aspect of the invention is formed of a sheet-shaped organic polarization member bonded to the surface of the compensator frame. In this case, the sheet-shaped organic polarization member can absorb the unwanted light so that leakage light and stray light resulting from the unwanted light will not be produced.

It is preferred that the projector further includes a second polarization maintaining reflector formed in correspondence with an adhesive surface between the optical compensator and the compensator frame. Providing the second polarization maintaining reflector prevents leakage light and stray light from being produced when the polarization state of the unwanted light is disturbed at the adhesive surface between the optical compensator and the compensator frame.

It is preferred that the polarization maintaining reflector or the polarized light absorber is formed on the surface of the light modulation device. In this case, the polarization state of the unwanted light can be appropriately adjusted on the surface of the light modulation device.

### BRIEF DESCRIPTION OF THE DRAWINGS

The invention will now be described with reference to the accompanying drawings, wherein like numbers refer to like elements.

FIG. 1 is a conceptual view describing the configuration of a projector according to a first embodiment.

FIGS. 2A and 2B are a front view and a side view, respectively, for describing an example of the configuration of a light modulator.

FIG. 3 is a side view for describing how light is handled in the light modulator.

FIG. 4 is a side view of an optical compensator and describes how light is handled in another light modulator.

FIG. 5 is a side view of an optical compensator and describes how light is handled in still another light modulator.

FIGS. 6A and 6B describe a second embodiment and are a plan view and a side view of a compensator frame, respectively, showing how unwanted light is handled in a light modulator by using absorption.

FIGS. 7A and 7B describe a third embodiment and show how unwanted light is handled in a portion where an optical compensator is bonded to a compensator frame in a light modulator.

FIGS. 8A and 8B describe a fourth embodiment and are a front view of a liquid crystal panel for describing another example of the configuration of a light modulator and a side view of the light modulator.

### DESCRIPTION OF EXEMPLARY EMBODIMENTS

### First Embodiment

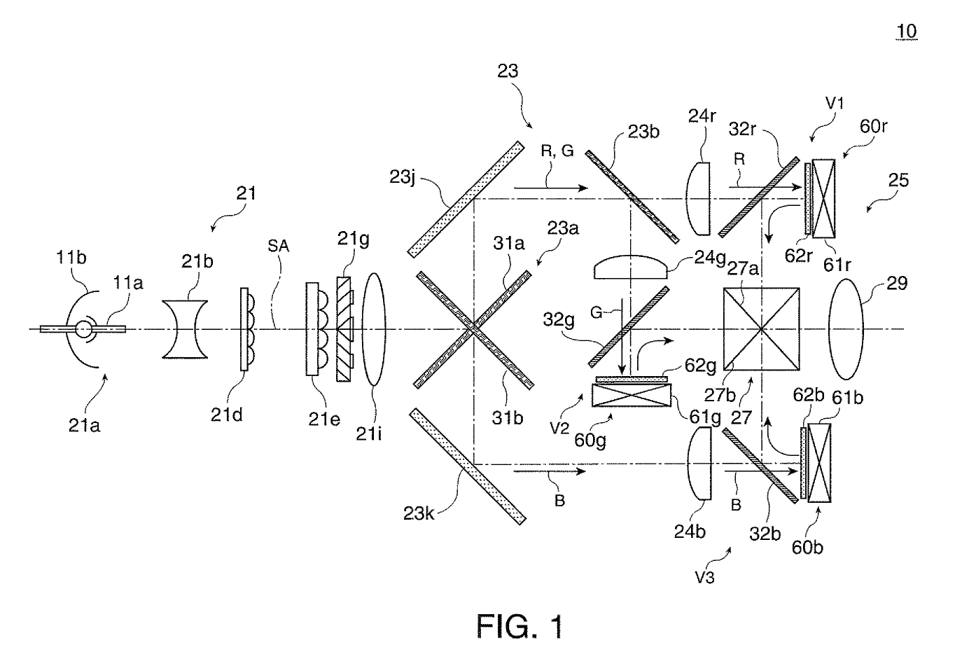

FIG. 1 is a conceptual plan view describing the configuration of the optical system of a projector according to a first embodiment of the invention.

The projector 10 includes a light source system that emits light-source light, a color separation/light guiding system 23 that separates the light-source light outputted from the light source system into red, green, and blue (RGB) three color light beams, a light modulating section 25 illuminated with the color light-source light beams having passed through the color separation/light guiding system 23, a cross dichroic prism 27 that combines the color image light beams outputted from the light modulating section 25, and a projection lens 29, which is a projection system that projects the image light having passed through the cross dichroic prism 27 on a screen (not shown). Among the components described above, the light source system 21, the color separation/light guiding system 23, the light modulating section 25, and the cross dichroic prism 27 form an image forming apparatus that forms image light to be projected on the screen.

In the thus configured projector 10, the light source system 21 includes a light source lamp 21a, a concave lens 21b, a pair of fly's-eye systems 21d and 21e, a polarization conversion member 21g, and a superimposing lens 21i. The light source lamp 21a includes a high-pressure mercury lamp or any other suitable arc tube 11a and a concave mirror 11b that collects the light-source light and directs it forward. The concave lens 21b serves to parallelize the light-source light from the light source lamp 21a. When the concave mirror 11b for the light source lamp 21a has a parabolic shape, the concave lens 21b can be omitted. Each of the pair of fly's-eye systems 21d and 21e is formed of a plurality of element lenses arranged in a matrix in a plane perpendicular to a system optical axis SA. The element lenses divide the light-source light having been emitted from the light source lamp 21a and passed through the concave lens 21b into sub-light beams, each of which then converges or diverges. The polarization conversion member 21g converts the light-source light having passed through the fly's-eye system 21e into, for example, light having only a P-polarized light component parallel to the plane of view of FIG. 1 and supplies the converted light to the downstream optical system in the optical path. The superimposing lens 21i causes as appropriate the light-source light having passed through the polarization conversion member 21g to converge as a whole to allow superimposed illumination on light modulators for the respective colors provided in the light modulating section 25. That is, the light-source light having passed through the fly's-eye system 21d, 21e and the superimposing lens 21i passes through the color separation/light guiding system 23, which will be described below in detail, and provides uniform superimposed illumination on light modulators 60r, 60g, and 60b for the respective colors provided in the light modulating section 25.

The color separation/light guiding system 23 includes a cross dichroic mirror 23a, a dichroic mirror 23b, and reflection mirrors 23j and 23k. In the color separation/light guiding system 23, the light-source light, which is substantially white light, from the light source system 21 is incident on the cross dichroic mirror 23a. The red (R) light reflected off a first dichroic mirror 31a, which is one of the dichroic mirrors that form the cross dichroic mirror 23a, is reflected off the reflection mirror 23j, passes through the dichroic mirror 23b, passes through a field lens 24r provided in a downstream section, where the light flux is adjusted in terms of a certain property but remains, for example, P-polarized, and is incident on a polarization separation element 32r, which is a reflective polarizer. Similarly, the green (G) light reflected off the first dichroic mirror 31a is reflected off the reflection mirror 23j as well as the dichroic mirror 23b, passes through a field lens 24g provided in a downstream section, where the light flux is adjusted in terms of a certain property but remains, for example, P-polarized, and is incident on a polarization separation element 32g, which is a reflective polarizer. On the other hand, the blue (B) light reflected off a second dichroic mirror 31b, which is the other one of the dichroic mirrors that form the cross dichroic mirror 23a, is reflected off the reflection mirror 23k, passes through a field lens 24b provided in a downstream section, where the light flux is adjusted in terms of a certain property but remains, for example, P-polarized, and is incident on a polarization separation element 32b, which is a reflective polarizer.

The light modulating section 25 includes the three polarization separation elements 32r, 32g, and 32b, and the three reflective light modulators 60r, 60g, and 60b. Each of the three polarization separation elements 32r, 32g, and 32b is, for example, a wire-grid polarization separation element that transmits P-polarized light and reflects S-polarized light. The three reflective light modulators 60r, 60g, and 60b include liquid crystal panels 61r, 61g, and 61b and optical compensators 62r, 62g, and 62b, respectively. Each of the liquid crystal panels 61r, 61g, and 61b is a non-luminous, reflective light modulation device capable of modulating the spatial intensity distribution of the incident light to form image light by changing the polarization state of the incident light and reflecting the resultant light. Each of the optical compensators 62r, 62g, and 62b optically compensates the liquid crystal characteristics by adjusting the polarization states of the light incident on and outputted from the liquid crystal panels 61r, 61g, and 61b.

In the above description, the polarization separation element 32r and the light modulator 60r for R light form a light valve V1 for R light for modulating the R light-source light two-dimensionally in terms of luminance based on image information. Similarly, the polarization separation element 32g and the light modulator 60g for G light form a light valve V2 for G light for modulating the G light-source light two-dimensionally in terms of luminance based on image information. Further, the polarization separation element 32b and the light modulator 60b for B light form a light valve V3 for B light for modulating the B light-source light two-dimensionally in terms of luminance based on image information.

The R light having been separated when passed through the dichroic mirror 23b in the color separation/light guiding system 23 is incident on the first light modulator 60r for R light via the polarization separation element 32r. The G light having been separated when reflected off the dichroic mirror 23b in the color separation/light guiding system 23 is incident on the second light modulator 60g for G light via the polarization separation element 32g. The B light having been separated when reflected off the second dichroic mirror 31b in the color separation/light guiding system 23 is incident on the third light modulator 60b for B light via the polarization separation element 32b.

In the light modulators 60r, 60g, and 60b, the three color light beams having passed through the optical compensators 62r, 62g, and 62b and incident on the liquid crystal panels 61r, 61g, and 61b are modulated in accordance with drive signals or image signals inputted as electric signals to the liquid crystal panels 61r, 61g, and 61b. In this process, the polarization separation elements 32r, 32g, and 32b adjust the polarization directions of the light-source light beams to be incident on the light modulators 60r, 60g, and 60b so that the light-source light beams are accurately P-polarized. The polarization separation elements 32r, 32g, and 32b then extract S-polarized light components as image light from the modulated light outputted from the light modulators 60r, 60g, and 60b. In this process, the optical compensators 62r, 62g, and 62b perform optical compensation in which retardation left in the liquid crystal panels 61r, 61g, and 61b is effectively canceled by adjusting the polarization states of the light passing through the optical compensators 62r, 62g, and 62b. The compensation made in the optical compensators 62r, 62g, and 62b improves the contrast of the modulated light.

The cross dichroic prism 27, which is a light combining member, is formed by bonding four rectangular prisms and thus has a substantially square shape when viewed from above. A pair of X-shaped, intersecting dielectric multilayer films 27a and 27b are formed along the interfaces between these bonded rectangular prisms. One of the dielectric multilayer films, the first dielectric multilayer film 27a, reflects R light, and the other one, the second dielectric multilayer film 27b, reflects B light. In the cross dichroic prism 27, the R light from the light modulator 60r is reflected off the first dielectric multilayer film 27a and outputted to the left when viewed in the traveling direction. The G light from the light modulator 60g passes through the first and second dielectric multilayer films 27a, 27b and goes straight through the cross dichroic prism 27. The B light from the light modulator 60b is reflected off the second dielectric multilayer film 27b and outputted to the right when viewed in the travelling direction.

The projection lens 29 projects the color image light combined in the cross dichroic prism 27 at a desired magnification on the screen (not shown). That is, color video images or a color still image corresponding to the drive signals or image signals inputted to the liquid crystal panels 61r, 61g, and 61b is projected on the screen at a desired magnification.

In the present embodiment, in the thus configured projector 10 using the reflective liquid crystal panels 61r, 61g, and 61b, unwanted light components that are contained in the illumination light but are not effectively used in the light modulators 60r, 60g, and 60b are handled so that no leakage light or stray light will be produced from the unwanted light and hence the decrease in contrast of a projected image will be suppressed. In particular, in the present embodiment, using outer frames that hold the optical compensators 62r, 62g, and 62b to reflect unwanted light components prevents a light component whose polarization state coincides with that of the modulated light from being produced from the unwanted light. As a result, no light component originating from the unwanted light will be outputted along with the modulated light when the projector 10 projects an image.

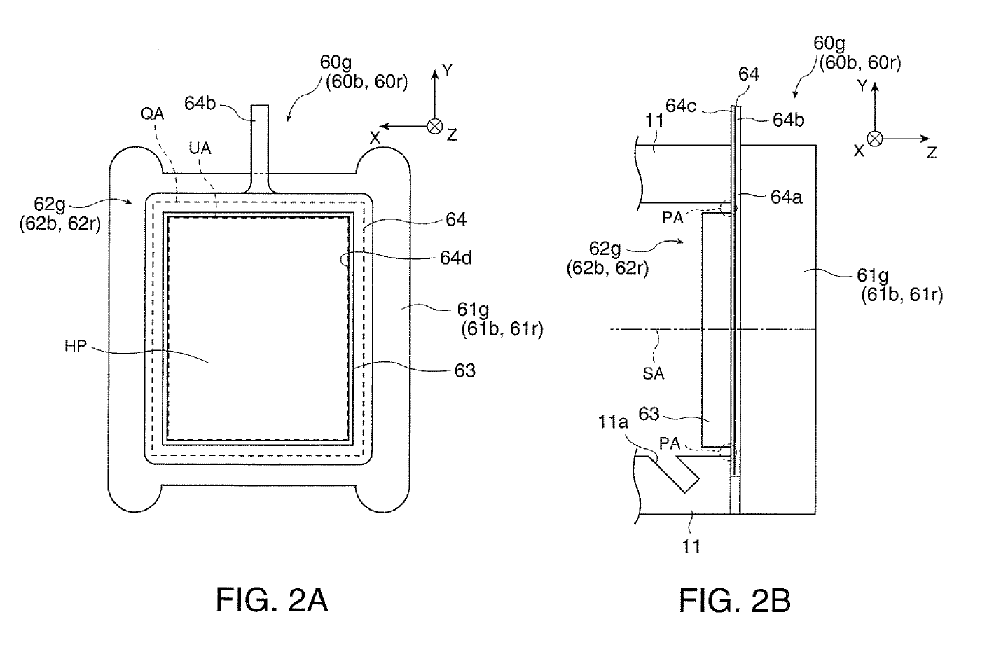

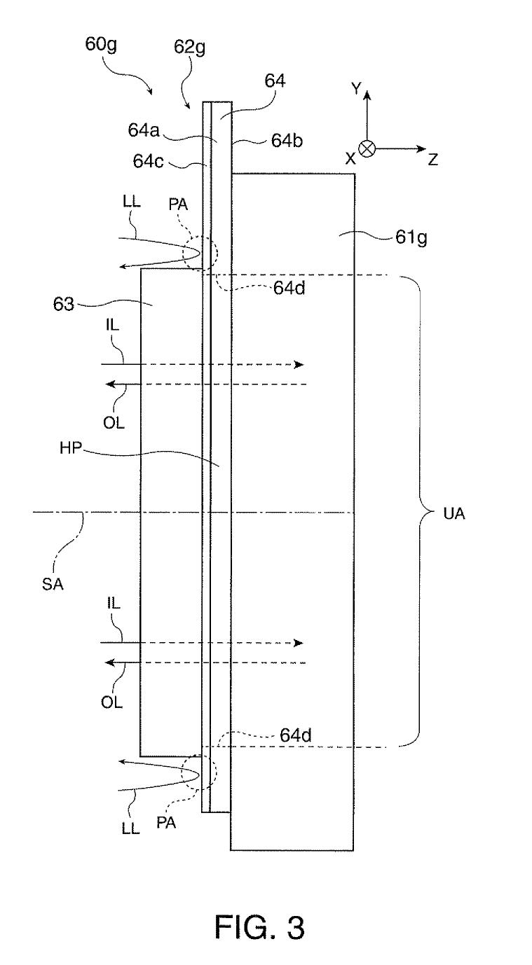

FIGS. 2A and 2B are a front view and a side view, respectively, for describing an example of the configuration of each of the light modulators 60r, 60g, and 60b. The light modulators 60r, 60g, and 60b have the same structure, and the light modulator 60g will be described below as a representative example and no description will be made of the others. FIG. 3 is a side view for describing how the light is handled in the light modulator 60g. The light modulator 60g includes the liquid crystal panel 61g and the optical compensator 62g, as described above. The optical compensator 62g includes an optical compensation element 63, which is a main portion, and a compensator frame 64, which is an outer holing frame that surrounds and supports the optical compensation element 63, as shown in FIGS. 2A and 2B.

The compensator frame 64 includes a frame body 64a, which is a main portion, and a position adjusting grip 64b. The frame body 64a and the grip 64b are made of a metal material, a plastic material, or any other suitable material. The frame body 64a is a frame member having a rectangular opening HP that substantially conforms to an effective pixel area UA of the liquid crystal panel 61g. The compensator frame 64 further includes a reflector 64c located on the side where the optical compensation element 63 is present (on the −Z side). The compensator frame 64 has a flat surface formed by depositing aluminum or any other suitable mirror processing technique.

The optical compensation element 63 is sized to be slightly larger than the opening HP of the compensator frame 64 and fixed onto the compensator frame 64 with an adhesive or any other suitable fasteners. The optical compensator 62g, when assembled, is sandwiched between the liquid crystal panel 61g and a case 11, which is a light guide that houses the entire optical system of the projector 1 shown in FIG. 1 and prevents light from entering. A groove 11a formed in the case 11 shown in FIG. 2B is used to assemble the polarization separation element 32g shown in FIG. 1. The liquid crystal panel 61g is assembled to the case 11 with screws or any other suitable fasteners (not shown) and hence the optical compensation element 63 is secured. When the optical compensator 62g is fixed, an edge portion 64d, which defines the opening HP of the compensator frame 64, is positioned to substantially coincide with the outer edge of the effective pixel area UA, which is an image light forming area of the liquid crystal panel 61g.

An illuminated area QA illuminated with the light incident on the light modulator 60g shown in FIG. 2A is sized to be slightly larger than and hence cover the effective pixel area UA so that the effective pixel area UA of the liquid crystal panel 61g receives at least certain illuminance. As a result, the illumination light incident on the light modulator 60g contains not only useful light that is incident on the effective pixel area UA of the liquid crystal panel 61g and effectively used to form modulated light but also, for example, an unwanted light component LL (see FIG. 3) that is incident on a peripheral area PA outside the effective pixel area UA but is not modulated. The light modulator 60g can handle the unwanted light component appropriately so that it will not affect image projection.

A description will be made of how the illumination light is handled in the light modulator 60g with reference to FIG. 3. First, in the light modulator 60g, incident light IL, which is useful light (G light) passing through the optical compensation element 63 and incident on the effective pixel area UA of the liquid crystal panel 61g, is reflected off the rear side of the liquid crystal panel 61g and modulated into exiting light OL in accordance with a drive signal or a control signal inputted as an electric signal to the liquid crystal panel 61g. The exiting light OL passes through the optical compensation element 63 again and exits therethrough. In the above process, the incident light IL, which is the G light having passed through the polarization separation element 32g shown in FIG. 1, is P-polarized light as described above, whereas the exiting light OL is, when it exits through the polarization separation element 32g, S-polarized light, which differs from the incident light IL in terms of polarization direction. That is, the light useful for projected image formation is incident on the light modulator 60g as P-polarized light but outputted therefrom as S-polarized light. The outputted useful light (G light), which has become S-polarized light, is reflected off the polarization separation element 32g shown in FIG. 1, and used as a component of the projected image. On the other hand, in FIG. 3, part of the components that form the illumination light directed to the light modulator 60g, the unwanted light LL incident on the peripheral area PA outside the effective pixel area UA, is reflected off the flat reflector 64c provided on the compensator frame 64 with the polarization state of the reflected light unchanged. It is noted that since the unwanted light LL has also passed through the polarization separation element 32g shown in FIG. 1, the unwanted light LL is P-polarized, which is the same as the incident light IL, when incident on the peripheral area PA. The unwanted light LL is, however, reflected off the reflector 64c and has the same polarization state or remains P-polarized. That is, the reflected unwanted light LL differs from the exiting light OL, which has become S-polarized light in the light modulator 60g, in terms of polarization state. The reflected unwanted light LL is therefore not reflected off the polarization separation element 32g shown in FIG. 1. As a result, the reflected unwanted light LL, which has returned from the portion outside the effective pixel area UA, can be separated from the modulated light, that is, the exiting light OL. It is therefore possible to avoid a situation in which the unwanted light LL and the exiting light OL are projected through the projection lens 29 as a projected image.

In the projector 10 of the present embodiment, the light modulators 60r and 60b as well as the light modulator 60g have the structure described above, and in each of the light modulators 60r, 60g, and 60b, the reflector 64c on the compensator frame 64 functions as a polarization maintaining reflector that reflects the unwanted light LL incident on the periphery of the corresponding one of the liquid crystal panels 61r, 61g, and 61b with the polarization state of the reflected light unchanged. In this way, unwanted light does not cause light leakage contained in a projected image, and hence the decrease in contrast of the image projected by the projector 10 is suppressed.

The frame body 64a of the compensator frame 64 has a frame-shaped structure with the rectangular opening HP in the above description but may not be configured this way. For example, the frame body 64a may have a plate-shaped structure made of quartz glass or formed of any other light transmissive substrate. In this case, the optical compensator 62g is formed by bonding the optical compensation element 63 to the light transmissive substrate, and the reflector 64c is provided in a frame-shaped peripheral portion of the optical compensation element 63 bonded to the light transmissive substrate. The optical compensator 62g thus functions as the polarization maintaining reflector.

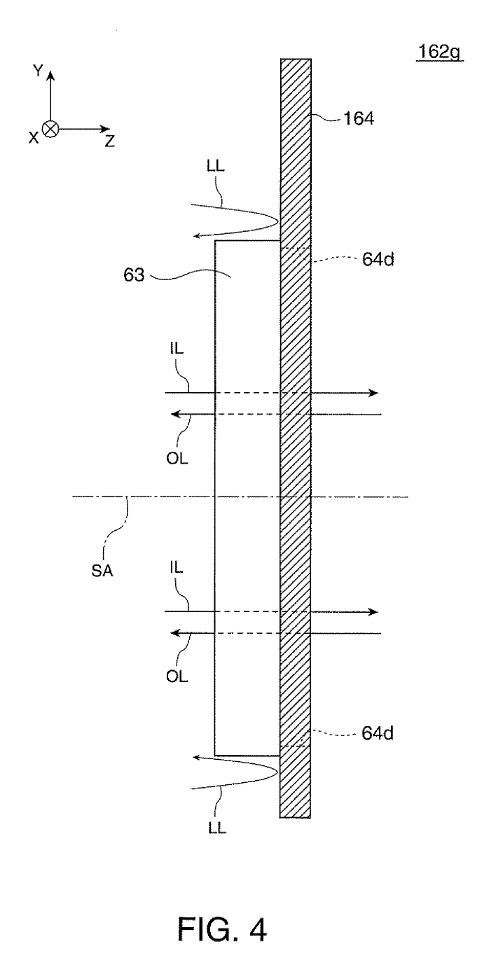

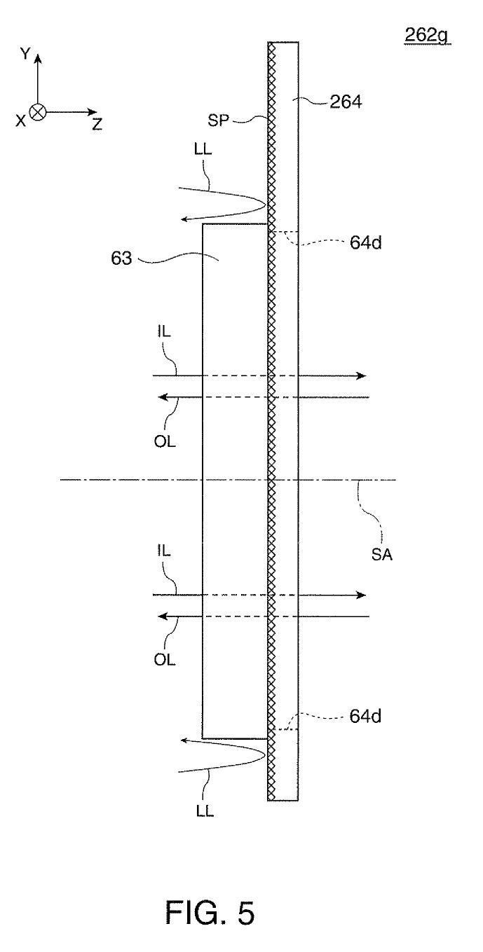

FIGS. 4 and 5 describe projectors according to variations of the present embodiment and are side views of optical compensators used in the projectors according to the variations. In each of the variations, no illustration or description will be made of the configurations of the portions other than the compensator frame because the configurations of those of the optical compensator other than the compensator frame are the same as those shown, for example, in FIG. 1.

An optical compensator 162g shown in FIG. 4 includes the optical compensation element 63 and a compensator frame 164. The compensator frame 164 is made of a material showing high reflectance. A specific useful example of the material of the compensator frame 164 is MIRO (product name). MIRO, an aluminum layer formed on a substrate and coated with a vacuum-deposited ultrahigh reflectance layer, is a member capable of maintaining high total reflectance of approximately 95% and reducing the diffusivity. Forming the compensator frame 164 by using MIRO allows the unwanted light LL to be reflected with its polarization state maintained, as in a case where a surface SP of the compensator frame 164 undergoes a mirror processing operation. Alternatively, the main portion of the compensator frame 164 may be made of a metal material or any other suitable material and the surface of the main portion may be coated with MIRO so that the compensator frame 164 functions as a polarization maintaining reflector.

An optical compensator 262g shown in FIG. 5 includes a compensator frame 264 made of aluminum or any other suitable metal material, and a flat surface SP of the compensator frame 264 that is closer to the optical compensation element 63 undergoes a mirror finishing operation. In this case as well, performing mirror finishing on the irregularity-free surface SP allows the unwanted light LL to be reflected with its polarization state unchanged. The optical compensator 262g is typically placed in an enclosed space, and hence there is conceivably little possibility that the mirror-finished surface is oxidized and degraded. It is noted, however, that the surface may further undergo a coating process as required. The compensator frame 264 may alternatively be made of a plastic material showing high optical reflectance when polished or otherwise surface-processed instead of using aluminum or any other suitable metal material.

### Second Embodiment

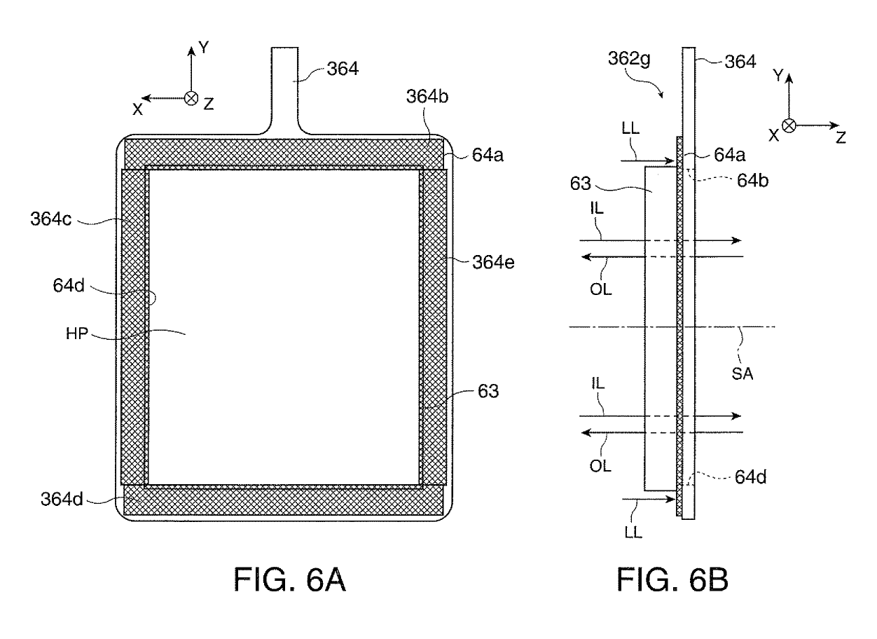

FIGS. 6A and 6B are a plan view and a side view, respectively, conceptually describing the configuration of an optical compensator used in a projector according to a second embodiment. In the projector according to the present embodiment, an optical compensator 362g absorbs the polarized unwanted light LL so that no leakage light or stray light is produced from the unwanted light LL and hence the unwanted light LL does not cause decrease in contrast of a projected image. The example shown in FIGS. 6A and 6B describes a variation of the projector 10 shown, for example, in FIG. 1, and portions that will not particularly be described are the same as those in the first embodiment.

In the present embodiment, the optical compensator 362g includes the optical compensation element 63 and a compensator frame 364. The compensator frame 364 includes the frame body 64a and organic polarization members 364b, 364c, 364d, and 364e. Each of the organic polarization members 364b to 364e, which are made of the same material, is a sheet-shaped absorbable organic polarization film and functions as a polarized light absorber that absorbs a specific polarized light component of the incident light components. The organic polarization members 364b to 364e are bonded to the surface of the frame body 64a that is on the side where the optical compensation element 63 is present along the edge portion 64d, which defines the shape of the opening HP of the compensator frame 364. The organic polarization members 364b to 364e are disposed in such a way that the transmission axis directions thereof are oriented in the same direction. Since the unwanted light LL having passed through the polarization separation element 32g shown in FIG. 1 is P-polarized light, the transmission axis directions of the organic polarization members 364b to 364e are aligned with the direction perpendicular to the polarization direction of the P-polarized light. As a result, the unwanted light component LL is absorbed and no leakage of light occurs. That is, any component whose polarization state coincides with that of the modulated light will not be produced. It is noted that the type of the organic polarization members 364b to 364e can be selected as appropriate and the extinction ratio thereof can be adequately set in accordance with the necessary amount of light to be absorbed and other factors.

The compensator frame 364 described above has the organic polarization members 364b to 364e provided on the frame body 64a, but may alternatively be replaced with a Flock Coated paper, which is added to the frame body 64a to absorb light. The light incident on the Flock Coated paper is repeatedly reflected off the side surfaces of the Flock, directed to the roots thereof, and then absorbed there. It is therefore possible to efficiently absorb light having a variety of polarization states, as compared with a case where a black paint is used to block light.

### Third Embodiment

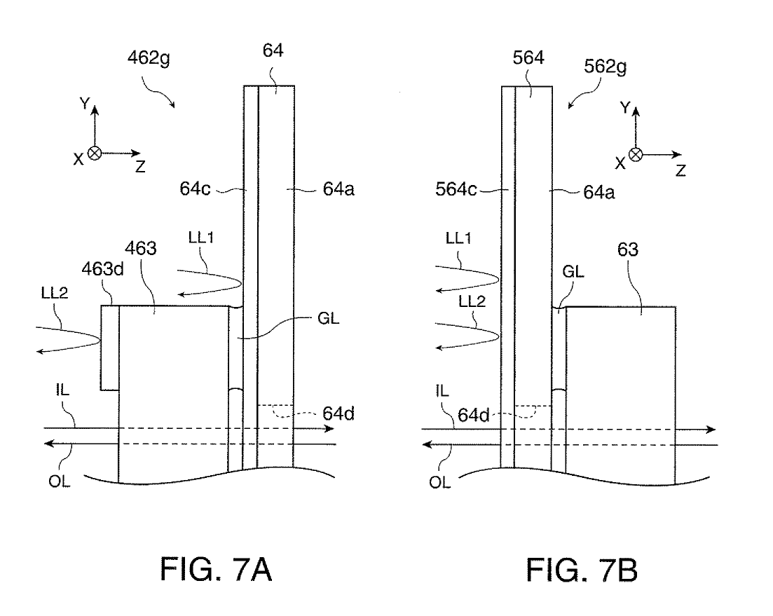

FIG. 7A is an enlarged partial side view conceptually describing the configuration of an optical compensator used in a projector according to a third embodiment. The example shown in FIG. 7A describes a variation of the projector 10 shown, for example, in FIG. 1, and portions that will not particularly be described are the same as those in the first embodiment.

In the present embodiment, an optical compensator 462g includes not only the reflector 64c, which is a typical polarization maintaining reflector, but also a second reflector 463d on an optical compensation element 463. The second reflector 463d functions as an auxiliary polarization maintaining reflector. In the optical compensator 462g, the optical compensation element 463 is bonded to the compensator frame 64 with an adhesive GL, such as a double-sided adhesive tape, placed continuously or intermittently at the periphery of the optical compensation element 463. When unwanted light is incident on the adhesive GL, the unwanted light is reflected and the polarization state thereof is disturbed, resulting in leakage of light having a S-polarized light component. To address the problem, in the optical compensator 462g, the second reflector 463d is formed in correspondence with the adhesive GL on the optical compensation element 463 to prevent unwanted light from entering the adhesive GL. The second reflector 463d is formed by using a mirror processing or any other suitable technique so that is has a flat surface, like the reflector 64c. This configuration allows unwanted light LL2 directed toward the adhesive GL to be reflected off the second reflector 463d with its polarization state maintained. On the other hand, unwanted light LL1 incident on a portion around the optical compensation element 463 is reflected off the reflector 64c with its polarization state maintained. The reflector 64c may be replaced with the organic polarization members 364b to 364e shown in FIGS. 6A and 6B, which function as polarized light absorbers that absorb the unwanted light LL1 when attached to the frame body 64a.

As shown in an optical compensator 562g in FIG. 7B, when the position of the optical compensation element and the position of a compensator frame 564 can be swapped, forming a reflector 564c on the surface of the compensator frame 564 that is opposite the side where the optical compensation element 63 is present allows not only the unwanted light L11 incident on a portion around the optical compensation element 63 but also the unwanted light LL2 directed toward the adhesive GL to be reflected. The position of the optical compensation element and the position of the compensator frame can be swapped in the embodiments described above as well.

### Fourth Embodiment

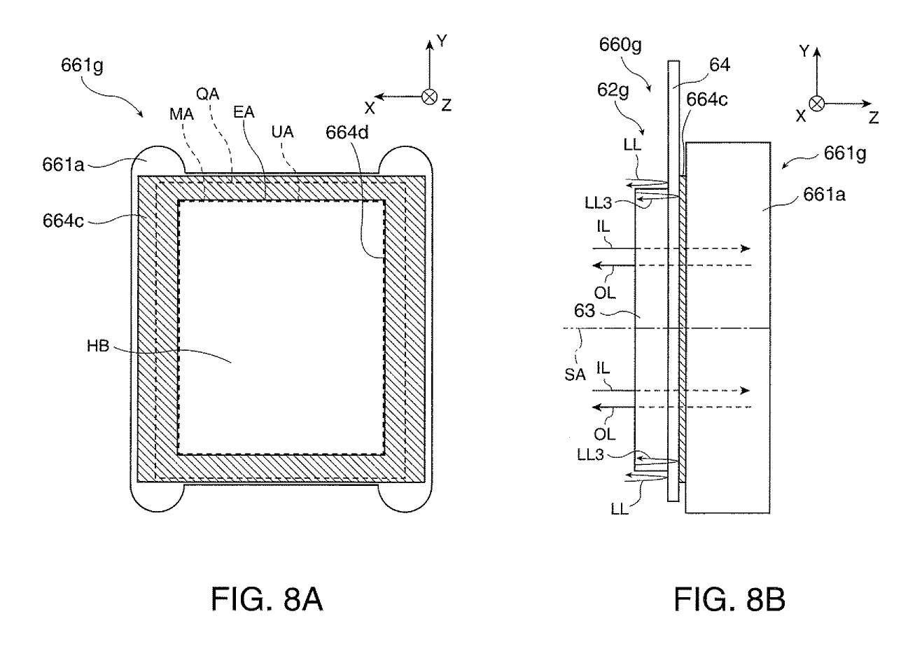

FIGS. 8A and 8B conceptually describe the configuration of a light modulator used in a projector according to a fourth embodiment. FIG. 8A is a front view of a liquid crystal panel 661g, and FIG. 8B is a side view of a light modulator 660g including the liquid crystal panel 661g. The example shown in FIGS. 8A and 8B describes a variation of the projector 10 shown, for example, in FIG. 1, and portions that will not particularly be described are the same as those in the first embodiment.

In the present embodiment, the liquid crystal panel 661g in the light modulator 660g includes a reflector 664c, which is a polarization maintaining reflector, on a liquid crystal panel front frame 661a. The reflector 664c has a rectangular opening HB having an edge portion 664d extending along a panel area EA of the liquid crystal panel 661g that is defined by the liquid crystal panel front frame 661a. The reflector 664c covers at least part of the illuminated area QA, a parting portion MA that is an area outside the panel area EA. The reflector 664c is a reflector made of a metal or organic material whose surface undergoes a mirror processing operation to remove irregularities, a reflector made of a metal or organic material whose surface undergoes a mirror finishing operation, or a reflector made of MIRO. Part of the panel area EA, an edge area located slightly outside the effective pixel area UA, is what is called a dummy pixel portion that is not used to form an image but typically designed to be displayed in black. As a result, the edge area does not reflect any light component or affect a projected image. When the optical compensation element 63 of the optical compensator 62g is sized to be slightly larger than the effective pixel area DA in order to ensure illuminance having at least a certain value therein, part of unwanted light LL3 may enter the parting portion MA of the liquid crystal panel 661g via the optical compensation element in some cases. The reflector 664c reflects the incident unwanted light LL3 with its polarization state maintained. That is, the unwanted light LL3 is handled by the reflector 664c, which functions as a polarization maintaining reflector. The reflector 664c may be replaced with the organic polarization members 364b to 364e shown in FIGS. 6A and 6B, which function as polarized light absorbers that absorb the unwanted light LL3 when attached to the liquid crystal panel front frame 661a.

While the invention has been described with reference to the above embodiments, the invention is not limited thereto. The invention can be implemented in a variety of aspects to the extent that they do not depart from the spirit of the invention. For example, the following variations can be employed.

First, the above embodiments have been described only with reference to the case where the P-polarized light beams having passed through the polarization separation elements 32r, 32g, and 32b are incident on the liquid crystal panels 61r, 61g, and 61b and the S-polarized light beams reflected off the polarization separation elements 32r, 32g, and 32b are outputted as image light. Alternatively, S-polarized light beams, for example, having been reflected off the polarization separation elements 32r, 32g, and 32b may be incident on the liquid crystal panels 61r, 61g, and 61b, and P-polarized light beams, for example, having passed through the polarization separation elements 32r, 32g, and 32b may be outputted as image light.

The above embodiments have been described with reference to a projector using what is called reflective liquid crystal panels. Alternatively, in a projector using transmissive liquid crystal panels that transmit light in their light modulation processes, stray light can be eliminated, for example, by providing optical compensators in the optical path in front of the liquid crystal panels or providing polarization maintaining reflectors or polarized light absorbers in front-side frames that form the liquid crystal panels.

In the projector 10 of any of the embodiments described above, the light source system 21 is formed of the light source lamp 21a, the pair of fly's-eye systems 21d and 21e, the polarization conversion member 21g, and the superimposing lens 211. The fly's-eye systems 21d and 21e, the polarization conversion member 21g, and other components may be omitted, and the light source lamp 21a may be replaced with any of an ultrahigh-pressure mercury lamp, a metal-halide lamp, an LED (light-emitting diode), or any other suitable light source.

In the projector 10 of any of the embodiments described above, the fly's-eye systems 21d, 21e and the superimposing lens 211 are used to illuminate the liquid crystal panels 61r, 61g, and 61b for the respective colors at brightness uniform in the planes thereof. The fly's-eye systems 21d, 21e and the superimposing lens 21i may be replaced with an integrator rod optical system.

In the embodiments described above, after the color separation/light guiding system 23 is used to separate the light-source light in terms of color, and the color light beams are modulated by the light modulating section 25, the cross dichroic prism 27 combines the color images. Alternatively, a single liquid crystal panel, that is, a light valve, may be used to form an image.

The above embodiments have been described only with reference to the projector 10 using the three liquid crystal panels 61r, 61g, and 61b. The invention is also applicable to a projector using two liquid crystal panels and a projector using four or more liquid crystal panels.

The projector 10 of any of the embodiments described above can be used as a front projector in which an image is projected from the viewer's side, where the viewer observes the screen, but also as a rear projector in which an image is projected from the side that is opposite the viewer's side.

The entire disclosure of Japanese Patent Application No. 2009-075939, filed Mar. 26, 2009 is expressly incorporated by reference herein.

What is claimed is:

1. A projector comprising:
a light modulation device that changes the polarization state of incident light; and
a polarization maintaining reflector provided along the outer edge of an effective pixel area in the light modulation device, the polarization maintaining reflector having a flat surface that reflects the incident light with its polarization state maintained.

2. The projector according to claim 1,
the light modulation device is a reflective liquid crystal panel, and
the projector further comprising a polarization separation element that transmits one of a light component polarized in a first direction and a light component polarized in a second direction contained in the light from the light modulation device and reflects the other polarized light component.

3. The projector according to claim 1,
further comprising an optical compensator that compensates the polarization state of the light incident on the light modulation device and a compensator frame that surrounds and supports the optical compensator along the outer edge of the effective pixel area of the light modulation device, and
wherein the polarization maintaining reflector is formed on the compensator frame.

4. The projector according to claim 3,
wherein the polarization maintaining reflector is formed by carrying out a process in which the surface of the compensator frame undergoes a mirror processing operation.

5. The projector according to claim 3,
wherein the polarization maintaining reflector is formed by using MIRO for the compensator frame.

6. The projector according to claim 3,
wherein the polarization maintaining reflector is formed by carrying out a process in which the surface of the compensator frame undergoes a mirror finishing operation.

7. The projector according to claim 3,
further comprising a second polarization maintaining reflector formed in correspondence with an adhesive surface between the optical compensator and the compensator frame.

8. The projector according to claim 1,
wherein the polarization maintaining reflector is formed on the surface of the light modulation device.

9. A projector comprising:
a light modulation device that changes the polarization state of incident light; and
a polarized light absorber provided along the outer edge of an effective pixel area in the light modulation device, the polarized light absorber absorbing a specific polarized light component of the light components of the incident light.

10. The projector according to claim 9,
the light modulation device is a reflective liquid crystal panel, and
the projector further comprising a polarization separation element that transmits one of a light component polarized in a first direction and a light component polarized in a second direction contained in the light from the light modulation device and reflects the other polarized light component.

11. The projector according to claim 9,
further comprising an optical compensator that compensates the polarization state of the light incident on the light modulation device and a compensator frame that surrounds and supports the optical compensator along the outer edge of the effective pixel area of the light modulation device, and
wherein the polarized light absorber is formed on the compensator frame.

12. The projector according to claim 11,
wherein the polarized light absorber is formed of a sheet-shaped organic polarization member bonded to the surface of the compensator frame.

13. The projector according to claim 11,
further comprising a second polarization maintaining reflector formed in correspondence with an adhesive surface between the optical compensator and the compensator frame.

14. The projector according to claim 9,
wherein the polarized light absorber is formed on the surface of the light modulation device.
